(19) United States
(12) Patent Application Publication
(10) Pub. No.: US 2024/0232954 A1
(43) Pub. Date: Jul. 11, 2024

(54) PERSONAL VIDEO COMMERCIAL STUDIO SYSTEM

(71) Applicant: ONEVA, INC., Oakland, CA (US)

(72) Inventors: Robert Page GARDYNE, Oakland, CA (US); Anita Lynne Darden GARDYNE, Oakland, CA (US)

(21) Appl. No.: 18/611,557

(22) Filed: Mar. 20, 2024

Related U.S. Application Data
(63) Continuation of application No. 16/131,691, filed on Sep. 14, 2018, now abandoned.
(60) Provisional application No. 62/559,324, filed on Sep. 15, 2017.

(51) Int. Cl. G06Q 30/0241; G06F 3/01; G06Q 30/02; G10L 15/26; G10L 25/60; G11B 27/031; H04N 5/33; H04N 21/81

(52) U.S. Cl. CPC G06Q 30/0276; G06F 3/013; G06Q 30/02; G10L 15/26; G10L 25/60; G11B 27/031; H04N 5/33; H04N 21/812; G06F 2203/011

(57) ABSTRACT

Disclosed are systems, devices, and processes to create a successful and effective personal video commercial through the use of one or more scripts, timecode commands, storyboarding, teleprompting displays, analyzers directed to static defects, eye contact, facial expression, and audio spoken word defects, automated video splicing, and video content and quality scoring, and feedback of the scoring.

### CROSS-REFERENCE TO RELATED APPLICATIONS

This application is a continuation of U.S. application Ser. No. 16/131,691, filed Sep. 14, 2018, which claims the benefit of U.S. Provisional Application No. 62/559,324, filed Sep. 15, 2017, each of which is hereby incorporated by reference in its entirety.

### BACKGROUND OF THE INVENTION

In the new web based economy, service providers can offer many services via web and mobile application. Video media and video-based content are effective ways to communicate and identify service providers in the new web based economy.

### SUMMARY OF THE INVENTION

The advent of YouTube and similar consumer video services that allow one to upload videos has created an ocean of content, the majority of which is of the lowest quality possible. People face many hurdles creating professional quality video of themselves for personal marketing purposes, known here as personal video commercials. Problems associated with generating personal video commercials include script generation, lack of professional feedback or training, lack of professional audio and video recording equipment, lack of direction, lack of means or standards with which to determine video quality, the inability to preprocess and edit raw video clips to optimize audio and video playback, and challenges with posting and/or distributing the finished product.

Over 300 hours of video content is uploaded to YouTube every single minute and the vast majority of those videos lack a professional touch. Lack of eye contact, poor usage of words, low quality voice and image capturing, as well as bad editing are only a few of the myriad of problems that plague so many of the videos uploaded to the internet on a daily basis. Many, but not all of these videos are intended to be used for a professional, semi-professional, or at least presentational purpose. A professional purpose may be the promotion of a restaurant, dance studio, or bakery, as well as a video showcasing a candidate for a particular position at a job. A semi-professional video might include the recording of a speech such as a TED talk or other inspirational video to share for later rebroadcast or post to social media. Other videos may be personal v-logs such as diaries or personal opinions about politics, sports, or thousands of other topics. All of these videos suffer from an overall lack of quality production. The very nature of YouTube promotes the potential for millions of these videos to be low in quality spending the rest of their life in an endless and ever-expanding cyberspace because any person, group, or entity can upload nearly any video onto YouTube, so long as they abide by the very loose user standards YouTube places on its contributors. The result is that the majority of videos posted on YouTube are of shockingly poor quality and do little more than continue to flood the internet with content that is lacking in multiple areas.

A bad script will doom a video. The challenges of writing a script for personal video commercial are significant, and exacerbated by the desire and perceived ease of posting a video. Most videos posted to YouTube do not require a script at all such as videos of pranks videos, dashcam footage, unboxings, pirated episodes of television shows or movies, and, famously, pet videos. Script, screenplay or storyboard generation are not mass-market products, and not widely known or available in the consumer space. However, there is a large segment of the videos that are uploaded to YouTube, the content of which could be greatly improved if a script had been produced and followed. For some of these videos, people actually have a script but fail to follow it. An informational video developed without professional marketing experience or guidelines will have no script or a poor script to the detriment of the quality of the video and the purpose for which it serves. The introduction of a professionally created script, including a pleasant introduction, organized description of offering, and closing with a clear call to action, will help to alleviate and eliminate most if not all of the problems that arise when a script is not present Many people do not have particularly good writing skills or English language skills or experience writing for video, and those people would all benefit immensely from a professional script personally being generated and tailored uniquely for them.

Another major component of video production that is lost on many uploaders is the lack of professional video equipment, including but not limited to cameras, mounts, lights, background, and reflectors, and professional audio equipment, including but not limited to microphones, preamplifiers, stands, baffles, acoustic panels, sound effects, and mixers, being used to produce a professional quality video. This tends to be the case for the majority of people who are just beginning to upload videos to YouTube, many of whom will only use their cell phone or computer camera and microphone. The advantages in terms of overall video quality cannot be denied when you compare these low-quality videos to those in which professional equipment is used. Professional lighting, cameras, microphones, and the use of equipment such as teleprompters, clapperboards, boom sticks, and sophisticated editing software serve to increase the quality of videos. Narration and the use of licensed third-party audio and/or video clips, frequently used in professional commercials, also enhance personal video commercials. One can see the improvements from long time YouTubers who initially used poor equipment and editing software to create and upload their videos compared to their more recent videos in which better equipment was used. Unfortunately, the majority of individuals who upload videos to the internet do not have the means, the knowledge or the desire to use this type of equipment. Consequently, the great mass of videos uploaded to the ever-expanding ocean of content is lacking even a semblance of professional influence.

There are no means or set standards one can use to review the quality of a video This reality sets the stage for a massive amount of videos all with huge variations in quality. Because there is no set standard for informational type videos or videos that would benefit from a script, many of them fail to adequately present the information that the uploader intended to include. Additionally, the plethora of other video issues including but not limited to the ones mentioned earlier contribute and translate to an overall lack of quality for a majority of the videos uploaded on a daily basis.

Many YouTube videos do not necessitate the need for professional direction, feedback, or training because their content is meant to be raw and unedited such as the world-famous video “Charlie Bit My Finger”. However, other videos such as informational videos can and do benefit from professional direction and training during the video capture portion of the video shoot. It is difficult if not impossible to edit away poor content if that content is beyond repair. Sometimes people must re-shoot videos that were initially unusable due to poor overall quality and content. Active training and feedback coupled with professional direction can help alleviate many of the negative realities that arise when attempting to shoot a video to upload on the internet. Again, not all videos require this, in fact, some do not at all. However, there is a dedicated subset of videos, especially those used for personal marketing, that would greatly benefit from planning and post shooting feedback followed by subsequent edits or re-shoots.

When a video has been completed, its creator usually chooses to upload the video regardless of glaring issues such as poor eye contact, stuttering, long pauses, subject off center, rambling, poor word choices, incomplete story or narrative, and other problems all of which stem from a lack of professional feedback and script training. The quality of a video can be limited due to an inability to preprocess raw video clips. Recorded audio levels vary from user to user and take to take, and are often too low in volume, which frequently causes increases in apparent noise as the weak audio is amplified to proper levels. Video filtering and processing can significantly improve the quality of video, reducing shadows using gamma adjustment or color correcting to adjust for lighting.

Complicated editing software intimidates many uploaders preventing most from even attempting to use the various editing software at their disposal. YouTube and the iPhone have basic built in editing tools we know are underused due to the majority of videos that are uploaded to the internet in which no editing has been performed. Edits including but not limited to splices with additional video clips of the client, splices with licensed third-party video clips, cuts, voiceovers, audio mixing or overdubbing with licensed third party audio clips, and text such as title and credits, as well as other common editing functions are lost on a majority of the individuals who upload videos to the internet. When people begin to personally upload videos after having received some editing training, the video still suffers from a lack of professional video editing. Editing and splicing multiple tracks into a single cohesive timeline with voiceovers, title, and credits among other editing techniques still remains a difficult task for new and mildly experienced uploaders.

Lastly, the challenges of posting and distributing a video, especially in a controlled manner, continue to be a problem for uploaders. With even a small number of megabytes, in the range of a few hundred, you cannot attach your video to the most common email services making it very hard to send a video to those who would be able to edit it. Also, many people who want to post videos online simply do not know how. Additionally, the lack of licensing and distribution management accessible to the average uploader makes the use of licensed third party audio or video clips and the controlled distribution of final personal video commercials is virtually impossible.

There are so many problems associated with producing a quality video that is intended to be uploaded to the internet. The lack of set standards in the industry coupled with the technical and physical qualifications necessary to bring a video up to professional quality inhibit most from producing and uploading quality videos to the internet. Not everyone requires that a professional touch be applied to their videos, but a large segment of the population that does upload videos online can greatly benefit from a multitude of video improving techniques many of which are outlined above. A vast majority of the content that is uploaded to the internet is poor in overall quality and individuals are not inherently adept at producing quality videos without the aid of others. This is the reason why professional social media sites such as LinkedIn still primarily use still photos instead of videos even though LinkedIn claims to have a technically sophisticated, affluent user base.

The system, devices, and processes described herein address this problem through, in some embodiments, a particular technological tool. The subject matter herein describes, in some cases, a computer-implemented system comprising: at least one personal video station comprising a visible light, a speaker, a microphone, a recording camera, a beam splitter, and a display device; a digital processing device comprising at least one processor, a memory, an operating system configured to perform executable instructions, and instructions executable by the at least one processor to create an application for creating a personal video commercial, the application comprising: i) a script selection module configured to select a script template from a library of one or more pre-existing script templates, wherein the script selection module selects the script template based on a user's input and a decision mechanism, wherein the script template comprises text and metadata, wherein the metadata comprises one or more sets of timecodes, weights, and targets, wherein the script selection module modifies the text and metadata based on the user's answers to template-supplied questions; ii) a script review module configured to accept audio data from the microphone and to modify the selected script template until the accepted audio data passes the threshold for all audio scoring methods using time-based and weighted scoring, wherein the audio data comprises the user's audible reading of some of the selected script template; iii) a script presentation module configured to present the threshold passing script template in the form of a script, wherein the script comprises one or more scripted timecodes; iv) iv) a display device module configured to project the script at the one or more scripted timecode from the display device to the beam splitter, which reflects the script to the user, wherein the projected script is presented in conjunction with visible light and the recording device recording the user; v) using time-variant weights and targets; and vi) a feedback module configured to display the score from the scoring module to the user through the display device and provide audio feedback through the speaker. In some embodiments, the system comprises an alignment module configured to determine a calculated timecode offset between the one or more scripted timecodes for a start of a phoneme, word, phrase or sentence in the script and a start of a spoken phoneme, word, phrase, or sentence by the user, and to modify the one or more scripted timecodes for future prompts and controls based on the calculated timecode offset. In some embodiments, the system comprises an editing module configured for editing, mixing, cutting, or splicing together audio and video clips. In some embodiments, the at least one personal video station further comprises an infra-red camera and an infra-red light. In some embodiments, the scoring of the recording using time-variant weights and targets comprises static defect analysis, spoken anomaly detection, cadence analysis, eye contact measurement, and emotional content analysis. In some embodiments, the at least one personal video station comprises, 2, 3, 4, 5, 6, 7, 8, 9, or 10 personal video stations. In some embodiments, the at least one personal video station comprises a laptop or desktop computer with internet access, an embedded or external camera, and microphone. In some embodiments, the at least one personal video station comprises a smart TV with internet access, an embedded or external camera, and microphone. In some embodiments, the at least one personal video station comprises a mobile device with internet access and a processor comprising artificial intelligence processing capabilities. In some embodiments, the personal video commercial presents multiple users over the duration of the video. In some embodiments, the multiple users are presented in sequence or concurrently. In some embodiments, the personal video commercial presents a product for sale or review by one or more individuals in a video. In some embodiments, the timecodes comprises one or more of ideal cadence, slowest permissible cadence and the fastest permissible cadence, time-encoded weights for multiple current and future audio and video scoring methods including spoken anomaly detection, cadence analysis, eye contact measurement, and emotional content analysis, time-encoded controls for lighting and audio and visual indicators, time-encoded stage direction for secondary displays in text, audio or video formats, and time-encoded training directions for prompts in normal and training modes. In some embodiments, the spoken anomaly detection comprises detection of stuttering, missing, or repeating. In some embodiments, the static defect analysis comprises sweat, spot, or stain detection, hair or makeup assessment, position or rotation assessment, lighting and background assessment, and ambient noise assessment and analysis. In some embodiments, the script library comprises scripts with samples of representative dialogue including ideal cadence, optimal time-varying weights, or scoring targets of a specific person's characteristics to be impersonated or duplicated, wherein the specific person's characteristics comprises the specific person's mannerism or voice. In additional embodiments, approximately co-axial camera and display eliminates the need for a beam splitter.

In another aspect, a method of creating a personal video commercial is provided. In some embodiments, the method of creating a personal video commercial comprises: a) providing at least one personal video station comprising a visible light, a speaker, a microphone, a recording camera, a beam splitter, and a display device; b) selecting a script template from a library of one or more pre-existing script templates based on a user's input and a decision mechanism, wherein the script template comprises text and metadata, wherein the metadata comprises one or more sets of timecodes and weights, and modifying the script template text and metadata based on the user's answers to template-supplied questions; c) accepting audio data from the microphone and modifying the selected script template until the accepted audio data passes the threshold for all audio scoring methods using time-based and weighted scoring, wherein the audio data comprises the user's audible reading of some of the selected script template; d) presenting the fully modified script template in the form of a script, wherein the script comprises one or more scripted timecodes; e) projecting the script at the selected timecode from the display device to the beam splitter, reflecting the script to the user, wherein the projected script is presented in conjunction with visible light and the recording device recording the user; f) scoring the recording using time-variant weights and targets and displaying the score to the user through the display device; and g) providing audio feedback through the speaker. In some embodiments, the method further comprises determining a calculated timecode offset between the one or more scripted timecodes for a start of a phoneme, word, phrase or sentence in the script and a start of a spoken phoneme, word, phrase, or sentence by the user and modifying the one or more scripted timecodes for future prompts and controls based on the calculated timecode offset. In some embodiments, the method further comprises one or more of editing, mixing, cutting, and splicing audio and video clips. In some embodiments, the at least one personal video station further comprises an infra-red camera and an infra-red light. In some embodiments, the method further comprises tracking the eye movement of the user using the infra-red camera or infra-red light. In some embodiments, the timecodes comprises one or more of ideal cadence, slowest permissible cadence and the fastest permissible cadence, time-encoded weights for multiple current and future audio and video scoring methods including, spoken anomaly detection, cadence analysis, eye contact measurement, and emotional content analysis, time-encoded controls for lighting and audio and visual indicators, time-encoded stage direction for secondary displays in text, audio or video formats, and time-encoded training directions for prompts in normal and training modes. In some embodiments, spoken anomaly detection comprises detection of stuttering, missing, or repeating. In some embodiments, static defect analysis comprises sweat, spot, or stain detection, hair or makeup assessment, position or rotation assessment, lighting and background assessment, and ambient noise assessment and analysis. In some embodiments, the script library comprises scripts with samples of representative dialogue including ideal cadence, optimal time-varying weights, or scoring targets of a specific person's characteristics to be impersonated or duplicated, wherein the specific person's characteristics comprises the specific person's mannerism or voice.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiment, in which the principles of the invention are utilized, and the accompanying drawings of which:

FIG. 1 shows a non-limiting example of a script; in this case, a script in the form of time-encoded commands to control various devices and processes required to create professionally produced and edited video commercials;

FIG. 2 shows a non-limiting example of a storyboard; in this case, a personal video commercial capture storyboard to manage the capture, analysis, and feedback of one or more video clips;

FIG. 3 shows a non-limiting example of a storyboard; in this case, a time-aligned storyboard where timecoded metadata is recoded to different timecodes to minimize the difference in alignment between word or phoneme boundaries in captured audio and expected audio timing from the text in the timecoded script;

FIG. 4 shows a non-limiting example of a process flow diagram; in this case, a process for creating and delivering a directed personal video commercial;

FIG. 5 shows a non-limiting example of a schematic diagram of a personal video commercial studio; in this case, a studio with one personal video station;

FIG. 6 shows a non-limiting example of a schematic diagram of a personal video commercial studio; in this case, a kiosk studio with two personal video stations;

FIG. 7 shows a non-limiting example of a schematic diagram of a personal video commercial studio; in this case, a studio with one personal video station based on a smartphone;

FIG. 8 shows a non-limiting schematic diagram of a digital processing device; in this case, a device with one or more CPUs, a memory, a communication interface, and a display;

FIG. 9 shows a non-limiting schematic diagram of a web/mobile application provision system; in this case, a system providing browser-based and/or native mobile user interfaces; and

FIG. 10 shows a non-limiting schematic diagram of a cloud-based web/mobile application provision system; in this case, a system comprising an elastically load balanced, auto-scaling web server and application server resources as well synchronously replicated databases.

### DETAILED DESCRIPTION OF THE INVENTION

Described herein, in certain embodiments, are systems, devices, and processes that interact with a client person to create a professionally produced and edited personal video commercial. The subject matter herein describes, in some cases, a computer-implemented system comprising: at least one personal video station comprising a visible light, a speaker, a microphone, a recording camera, a beam splitter, and a display device; a digital processing device comprising at least one processor, a memory, an operating system configured to perform executable instructions, and instructions executable by the at least one processor to create an application for creating a personal video commercial, the application comprising: i) a script selection module configured to select a script template from a library of one or more pre-existing script templates, wherein the script selection module selects the script template based on a user's input and a decision mechanism, wherein the script template comprises text and metadata, wherein the metadata comprises one or more sets of timecodes, weights, and targets, wherein the script selection module modifies the text and metadata based on the user's answers to template-supplied questions; ii) a script review module configured to accept audio data from the microphone and to modify the selected script template until the accepted audio data passes the threshold for all audio scoring methods using time-based and weighted scoring, wherein the audio data comprises the user's audible reading of some of the selected script template; iii) a script presentation module configured to present the threshold passing script template in the form of a script, wherein the script comprises one or more scripted timecodes; iv) a display device module configured to project the script at the one or more scripted timecode from the display device to the beam splitter, which reflects the script to the user, wherein the projected script is presented in conjunction with visible light and the recording device recording the user; v) using time-variant weights and targets; and vi) a feedback module configured to display the score from the scoring module to the user through the display device and provide audio feedback through the speaker. In some embodiments, the system comprises an alignment module configured to determine a calculated timecode offset between the one or more scripted timecodes for a start of a phoneme, word, phrase or sentence in the script and a start of a spoken phoneme, word, phrase, or sentence by the user, and to modify the one or more scripted timecodes for future prompts and controls based on the calculated timecode offset. In some embodiments, the system comprises an editing module configured for editing, mixing, cutting, or splicing together audio and video clips. In some embodiments, the at least one personal video station further comprises an infra-red camera and an infra-red light. In some embodiments, the scoring of the recording using time-variant weights and targets comprises static defect analysis, spoken anomaly detection, cadence analysis, eye contact measurement, and emotional content analysis. In some embodiments, the at least one personal video station comprises, 2, 3, 4, 5, 6, 7, 8, 9, or 10 personal video stations. In some embodiments, the at least one personal video station comprises a laptop or desktop computer with internet access, an embedded or external camera, and microphone. In some embodiments, the at least one personal video station comprises a smart TV with internet access, an embedded or external camera, and microphone. In some embodiments, the at least one personal video station comprises a mobile device with internet access and a processor comprising artificial intelligence processing capabilities. In some embodiments, the personal video commercial presents multiple users over the duration of the video. In some embodiments, the multiple users are presented in sequence or concurrently. In some embodiments, the personal video commercial presents a product for sale or review by one or more individuals in a video. In some embodiments, the timecodes comprises one or more of ideal cadence, slowest permissible cadence and the fastest permissible cadence, time-encoded weights for multiple current and future audio and video scoring methods including spoken anomaly detection, cadence analysis, eye contact measurement, and emotional content analysis, time-encoded controls for lighting and audio and visual indicators, time-encoded stage direction for secondary displays in text, audio or video formats, and time-encoded training directions for prompts in normal and training modes. In some embodiments, the spoken anomaly detection comprises detection of stuttering, missing, or repeating. In some embodiments, the static defect analysis comprises sweat, spot, or stain detection, hair or makeup assessment, position or rotation assessment, lighting and background assessment, and ambient noise assessment and analysis. In some embodiments, the script library comprises scripts with samples of representative dialogue including ideal cadence, optimal time-varying weights, or scoring targets of a specific person's characteristics to be impersonated or duplicated, wherein the specific person's characteristics comprises the specific person's mannerism or voice. In additional embodiments, approximately co-axial camera and display eliminates the need for a beam splitter.

In another aspect, a method of creating a personal video commercial is provided. In some embodiments, the method of creating a personal video commercial comprises: a) providing at least one personal video station comprising a visible light, a speaker, a microphone, a recording camera, a beam splitter, and a display device; b) selecting a script template from a library of one or more pre-existing script templates based on a user's input and a decision mechanism, wherein the script template comprises text and metadata, wherein the metadata comprises one or more sets of timecodes and weights, and modifying the script template text and metadata based on the user's answers to template-supplied questions; c) accepting audio data from the microphone and modifying the selected script template until the accepted audio data passes the threshold for all audio scoring methods using time-based and weighted scoring, wherein the audio data comprises the user's audible reading of some of the selected script template; d) presenting the fully modified script template in the form of a script, wherein the script comprises one or more scripted timecodes; e) projecting the script at the selected timecode from the display device to the beam splitter, reflecting the script to the user, wherein the projected script is presented in conjunction with visible light and the recording device recording the user; f) scoring the recording using time-variant weights and targets and displaying the score to the user through the display device; and g) providing audio feedback through the speaker. In some embodiments, the method further comprises determining a calculated timecode offset between the one or more scripted timecodes for a start of a phoneme, word, phrase or sentence in the script and a start of a spoken phoneme, word, phrase, or sentence by the user and modifying the one or more scripted timecodes for future prompts and controls based on the calculated timecode offset. In some embodiments, the method further comprises one or more of editing, mixing, cutting, and splicing audio and video clips. In some embodiments, the at least one personal video station further comprises an infra-red camera and an infra-red light. In some embodiments, the method further comprises tracking the eye movement of the user using the infra-red camera or infra-red light. In some embodiments, the timecodes comprises one or more of ideal cadence, slowest permissible cadence and the fastest permissible cadence, time-encoded weights for multiple current and future audio and video scoring methods including, spoken anomaly detection, cadence analysis, eye contact measurement, and emotional content analysis, time-encoded controls for lighting and audio and visual indicators, time-encoded stage direction for secondary displays in text, audio or video formats, and time-encoded training directions for prompts in normal and training modes. In some embodiments, spoken anomaly detection comprises detection of stuttering, missing, or repeating. In some embodiments, static defect analysis comprises sweat, spot, or stain detection, hair or makeup assessment, position or rotation assessment, lighting and background assessment, and ambient noise assessment and analysis. In some embodiments, the script library comprises scripts with samples of representative dialogue including ideal cadence, optimal time-varying weights, or scoring targets of a specific person's characteristics to be impersonated or duplicated, wherein the specific person's characteristics comprises the specific person's mannerism or voice.

Also described herein, in some embodiments, is a system and device that applies to the creation of video commercials that present a single individual for the duration of the video. In other embodiments, the subject matter is used for the creation of advertisement of services for individuals, video resumes for those seeking employment, training videos, or personal video messages for dating sites or social media. In even further embodiments, the subject matter applies to the creation of video commercials that present multiple individuals, in sequence or concurrently, over the duration of the video. In these embodiments, the subject matter may additionally be used for the creation of advertisements for teams or companies, training videos, or personal video messages. In other embodiments, the subject matter may also apply to the creation of video commercials that present a product for sale or review by one or more individuals in a video. In some embodiments, the subject matter applies to provide a client person with valuable training by providing real-time and post-recording feedback of audio and video performance, with training and feedback offered as a combined or separate service from video commercial production. In some embodiments, the subject matter applies to provide a client person with valuable training by providing real-time and post-recording feedback of audio and video performance to impersonate or duplicate the voice of a famous person or celebrity, cartoon character, or other real or fictitious personality, including the ability to train both vocal and facial expression to match the character to be impersonated.

Also described herein, in some embodiments, the subject matter resolves the concerns of creating a script format to manage and automate multiple synchronized video and audio recording systems; lighting, indicators and system controls; audible commands and tones; multiple, synchronized teleprompter displays with static and dynamic images including stage direction and training; multiple AI-based video and audio quality analysis systems, with time-alignment of weighted scoring to user cadence, for static image analysis of clothing, face, or hair defects, eye contact, eye contact measurement, facial expression assessment, and spoken word quality assessment.

Also described herein, in other embodiments, the subject matter resolves the concerns of script generation, script modification including audio training and feedback, professional recording environment and equipment, video clip quality assessment including audio/video training and feedback, pre-processing of separate video clips, assembly and post-processing of final video, approval of final video including assessment of audio/video quality, and controlled distribution.

Further described herein, in additional embodiments, the subject matter resolves the concern of the client select a professional script template using client input and a decision mechanism to select from a library of one or more pre-existing professionally developed script templates that includes text and metadata. In some embodiments, the subject matter may substitute words or phrases based on client answers to template-supplied questions or modifying the metadata such as timecodes and weights based on the substitutions. In some embodiments, the metadata may include one or more sets of timecodes comprising: ideal cadence, slowest permissible cadence and the fastest permissible cadence; time-encoded weights for multiple current and future audio and video scoring methods including static defect analysis, spoken anomaly (stutter, miss, repeat) detection, cadence analysis, eye contact measurement, and emotional content analysis; time-encoded controls for lighting and audio and visual indicators; time-encoded stage direction for secondary displays in text, audio or video formats; and time-encoded training directions for prompts in normal and training modes

Moreover, in other embodiments, the subject matter resolves the concern of reviewing and modifying the script by having the client read each sentence of the script separately, in groups of sentences, and the whole script, into a microphone. In further embodiments, the subject matter uses time-based and weighted scoring to assess ability of the client to perform adequately using that script. In even further embodiments, the subject matter provides training and feedback to the client. In additional embodiments, the subject matter may modify the script with sentence and word substitutions with associated modifications to script controls including timing and score weighting, until the client reading the script meets passing thresholds for all audio scoring methods using time-based and weighted scoring.

Further, in some embodiments, the subject matter resolves the concern of providing the device necessary to present the text script to client in conjunction with script-controlled indicators, signals, and audio-visual content necessary to direct client to create a professional video commercial displayed to client. In other embodiments, the subject matter uses one or more synchronized teleprompters, each locating an outgoing display of text to the client in conjunction with a coaxially aligned incoming beam of light to be captured as video. In even further embodiments, the subject matter utilizes one or more of the following features: ambient noise and light monitoring and control; script-controlled multipoint lighting; script-controlled indicators, signals, and audio-visual content for cadence direction; script-controlled indicators, signals, and audio-visual content for stage directions; script-controlled indicators, signals, and audio-visual content for training, and script-controlled commands to audio and video quality scoring devices such as reset, enable, or mode control.

Also, in other embodiments, the subject matter resolves the concern of providing the device necessary to record one or more synchronized and concurrent streams of primary and auxiliary audio and video content for use in the personal video commercial, and to record synchronized time-coded metadata into the electronic script file for use in audio and video quality scoring. In some embodiments, the subject matter uses one or more synchronized teleprompters each receiving an incoming beam of light to be captured as video while locating an outgoing coaxially aligned display of text to the client. In other embodiments, the subject matter utilizes one or more of the following features: auxiliary synchronized normal and infra-red cameras; auxiliary internal and external microphones; internal and external sensors; AI-based audio and video quality measurement systems such as static defect analysis, spoken anomaly (stutter, miss, repeat) detection, cadence analysis, eye contact measurement, and emotional content analysis, and time alignment of command and scoring time codes to user verbal cadence ALL to create time-coded metadata for scoring systems. In even further embodiments, the quality data may be recorded into the script concurrently and as the audio and video data are captured. In additional embodiments, the quality data and scores and processed after the video and audio has been recorded and then appended to the electronic script during or after the video recording.

Also described herein, in some embodiments, the subject matter resolves the concerns regarding recoding time codes in the script so as to align the start times for future prompts, indicators, script text, and time-variant weights for quality scoring mechanisms to match the start of spoken words read form the script into the microphone. In some embodiments, when spoken text is completed ahead of or before the expected time as specified by the script text timecodes and as measured by the start of each word or phoneme captured by the microphone, the timecodes for all future metadata in the script will be reduced by the difference between the start time of the spoken text and the expected time based on the script text timecode, such that future script timecodes will be, for that moment, synchronized to the cadence of the spoken text into the microphone, until such a time as the start time of spoken text deviates from expected script text timecodes. In some embodiments, when spoken text is completed following or after the expected time as specified by the script text timecodes and as measured by the start of each word or phoneme captured by the microphone, the timecodes for all future metadata in the script will be increased by the difference between the start time of the spoken text and the expected time based on the script text timecode, such that future script timecodes will be, for that moment, synchronized to the cadence of the spoken text into the microphone, until such a time as the start time of spoken text deviates from expected script text timecodes.

Also described herein, in some embodiments, the subject matter resolves the concerns regarding for scoring static defect analysis, spoken anomaly (stutter, miss, repeat, etc.) detection, cadence analysis, eye contact measurement, and emotional content analysis data recorded. In further embodiments, the subject matter uses electronic script time-coded script metadata from scoring systems such as static defect analysis, spoken anomaly (stutter, miss, repeat) detection, cadence analysis, eye contact measurement, and emotional content analysis. In additional embodiments, the subject matter utilizes one or more of the following features: time-encoded weights for the same multiple current and future audio and video scoring methods; and a means of calculating scores for data and weights with non-synchronized timecodes.

As described herein, in additional embodiments, the subject matter resolves the concerns regarding the display of feedback to the client using the primary display and speakers and secondary displays to present one or more of (1) one or more audio-video clips from the primary cameras in the synchronized teleprompters; (2) audio-video clips from auxiliary cameras; (3) prerecorded static and video stage directions; (4) pre-recorded static and video training; (5) data and score overlays from electronic script time-coded script metadata from one or more scoring systems such as static defect analysis, spoken anomaly (stutter, miss, repeat) detection, cadence analysis, eye contact measurement, and emotional content analysis; and (6) live audio or video conference from a call center. In additional embodiments, wired or wireless ear buds provide feedback to the client without presenting visible or audible evidence of such feedback to client.

As described herein, in other embodiments, the subject matter resolves the concerns regarding audio and video preprocessing for each video clip. In some embodiments the subject matter resolves this concern by adjusting audio volume to standard or other preferred industry levels. In other embodiments, the subject matter resolves this concern by applying standard audio tools such as filters to remove hiss and noise. In even further embodiments, the subject matter selects and trims the start and end points for the clip based on script time codes, speech to text conversion, and scores for eye contact and emotional expression. In additional embodiments, the subject matter applies standard video tools such as gamma correction and color filters to improve apparent video quality. In additional embodiments, the subject matter applies audio tools such as level correction and noise reduction, and mixes in licensed third-party audio and narrations, to improve apparent audio quality.

As described herein, in some embodiments, the subject matter resolves the concerns regarding assembly and post-processing of all video clips. In some embodiments, the subject matter resolves the concern for both unaugmented and augmented clips into unaugmented and augmented final videos. In other embodiments, the subject matter resolves the concern by doing one or more of the following: (1) splicing the unaugmented video clips together into an unaugmented final video using a non-linear editor; (2) splicing augmented video clips together into an augmented final video using a non-linear editor; (3) applying optional titles and trailers; (4) applying background music from licensed third-party sources or voice-over to replace existing audio content; (5) final application of audio filters for voiceover; or (6) conversion to desired final file format. In even further embodiments, one or more unaugmented video clips may be spliced together with one or more third-party licensed video clips into an unaugmented final video using a non-linear editor. In even further embodiments, licensed third-party audio clips may be mixed into or replace existing audio content.

As described herein, in other embodiments, the subject matter resolves the concerns regarding approval of final video. In some embodiments, the subject matter resolves this concern using a review of overall final video by client followed by feedback from client. In some other embodiments, the subject matter resolves this concern using scores from quality assessments against thresholds set for each script. And in even further embodiments, the subject matter resolves this concern using adjustment to approval thresholds based on answers to client questions (such as native English speaker).

As described herein, in some embodiments, the subject matter also resolves concerns for distribution by hosting the video on a website that allows controlled access, tracking, and distribution of completed videos. In further embodiments, the subject matter resolves the management of licensing and distribution for any third party video or audio clips.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Personal Video Commercial Script

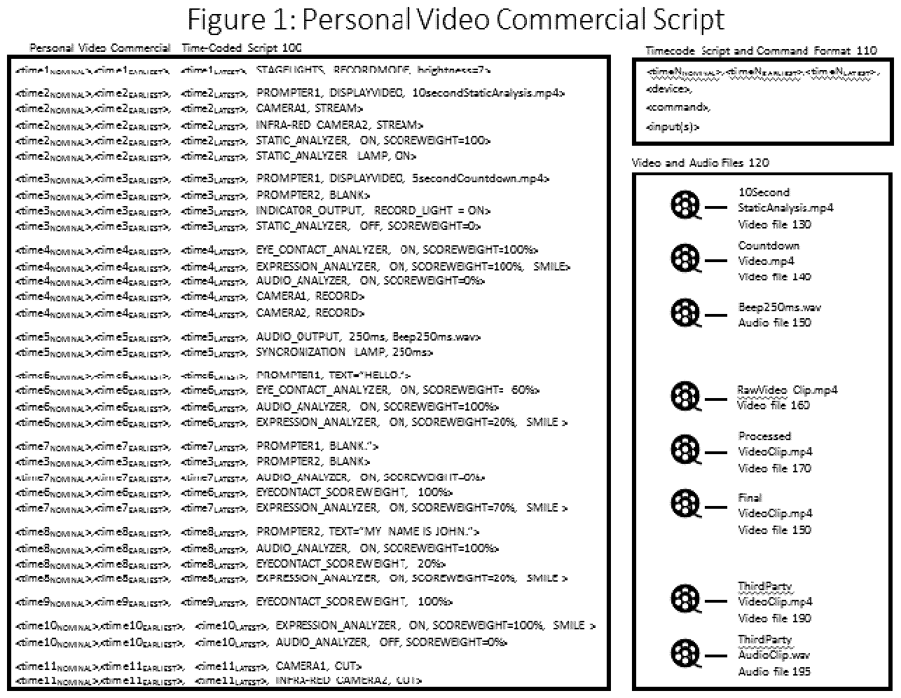

Referring to FIG. 1, in a particular embodiment, a script in the form of time-encoded commands to control various devices and processes required to create professionally produced and edited video commercials is provided. The script 100 is comprised of one or more commands each in the format Timecode Script and Command Format 110. Each timecode command described by Timecode Script and Command Format 110 includes the optimal and best time for that command to happen, the earliest time that command may be executed when time-aligned by user cadence, the latest time that command may be executed when time-aligned by user cadence, the device or system being commanded, the command, and any associated command input. Commands for commonly available subsystems, such as lighting and recording, may adapt existing commercial standards such as MIDI, whereas commands for AI-based measuring systems for eye contact, facial expression, and/or spoken word anomaly may be proprietary.

Continuing to refer to FIG. 1, the script 100 is associated and provided with one or more audio or video files for control, training and operation, including 10SecondStaticAnalysis.mp4 video file 130, Countdown Video.mp4 video file 140, and Beep250ms.wav audio file 150. The script 100 may further be stored or delivered with one or more licensed third party video clips such as ThirdParty VideoClip.mp4 Video file 190 or one or more licensed third party video clips such as ThirdParty AudioClip.wav Audio file 195. The script 100 may further be stored or delivered with one or more unprocessed video clips such as RawVideoClip.mp4 video file 160, one or more processed or edited video clips such as ProcessedVideoClip.mp4 video file 170, or one or more Final VideoClip.mp4 video clip 180.

### Personal Video Commercial Storyboard

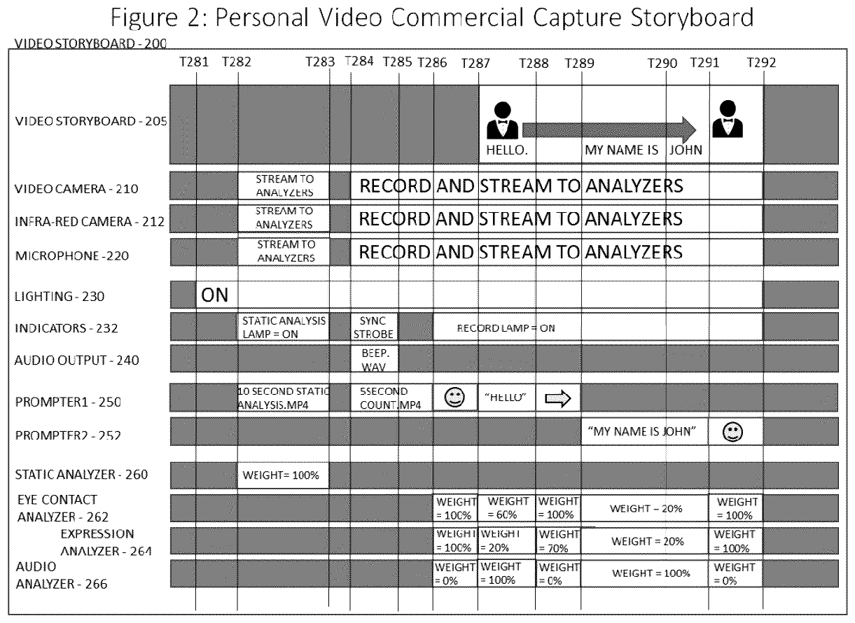

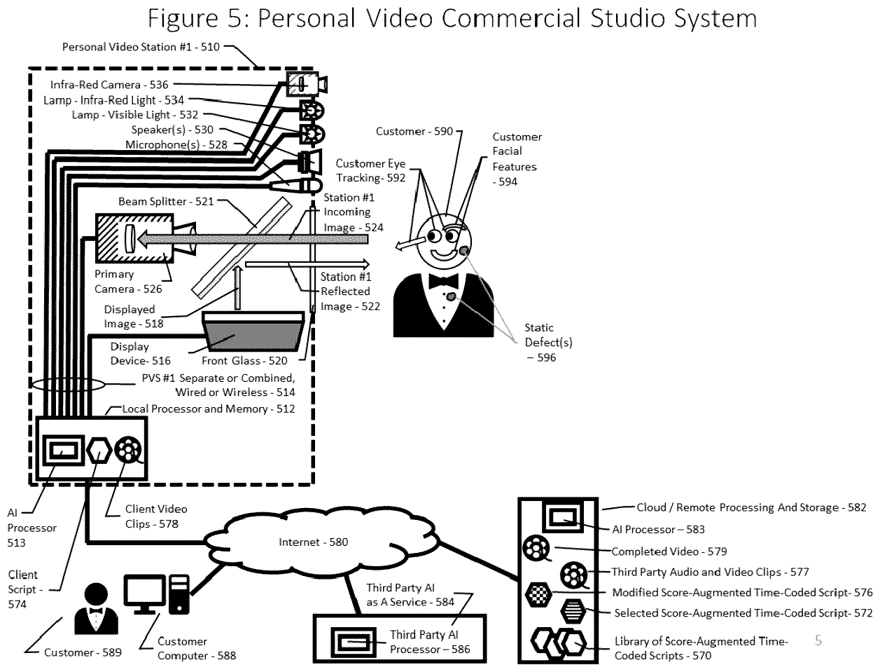

Referring to FIG. 2, in a particular embodiment, a personal video commercial capture storyboard to manage the capture, scoring, analysis, and feedback of one or more video clips. In some embodiments, the aforementioned script 100 commands and controls the commercial and proprietary subsystems to create an automated story board Video Storyboard 200 shown in FIG. 2. The Video Storyboard Overview 200 consists of one or more storyboard rows showing time-based activity for the desired output row Video Storyboard 205 as well as control for one or more Video Camera 210, one or more infra-red video cameras 212, audio microphones and recorders 220, lighting 230, audio output 240, one or more Teleprompter displays 250 and 252, static analyzer 260, eye contact analyzer 170, expression analyzer 264, and audio analyzer 266. In some embodiments, the script 100 signals that lighting 230 should be “on” for the duration of the video clip capture from times T281 to T292. In some embodiments, the script 100 signals that from times T282 to T283 static analysis of client should be performed using video camera 210, Infra-red camera 212, and microphone 220, at the same time prompting the client using Prompter1 250 or Prompter2 252 using the instructional video 10SecondStaticAnalysis.mp4 Video file 130, and at the same time signaling Static Analyzer 260 to perform sweat, spot or stain detection, hair or makeup assessment, position or rotation assessment, lighting and background assessment, ambient noise assessment and analysis. In some embodiments, the script 100 signals that from times T284 to T292, video camera 210, Infra-red camera 212, and microphone 220 are capturing video and audio to local storage FIG. 5-512 and/or to cloud storage FIG. 5-582 and performing static analysis 260 using local AI processor FIG. 5-513, remote AI processor FIG. 5-583 or third party AI as a Service FIG. 5-586. In some embodiments, the script 100 signals from times T284 to T285 that Indicator 232 turns on and off Lamp-visible light FIG. 5-532 and Lamp-infra-red light FIG. 5-534 with a specific duration and audio output 240 generates an identical duration control tone out of Speaker FIG. 5-530 to create time-alignment marks, similar to a movie production clapper, in video streams from video camera 210 and Infra-red camera 212 and in audio streams from microphone 220. In some embodiments, the script 100 signals from times T284 to T286 that a countdown video, such as 5SECONDCOUNT.MP4, is played and displayed on Prompter1 250 and/or Prompter2 252. In some embodiments, the script 100 signals that Indicator 232 turns on Record Lamp FIG. 5-532 from time T284 to T292 to indicate to client that video is being recorded. In some embodiments, the script 100 signals that icons and non-verbal cues are displayed on Prompter1 250 and Prompter2 252, for example a smile icon from times T286 to T287 to prompt the client to smile at the start of the video clip, an arrow icon from times T288 to T289 on Prompter1 250 to prompt the client to look at another camera, and a smile icon from times T291 to T292 on Prompter1 252 to prompt the client to smile at the end of the video clip. In some embodiments, the script 100 signals that text is to be displayed on Prompter1 250 and Prompter2 252 to prompt the client to say the written text, where the start of each word, sentence, or phrase has been coded with an early, optimal, and late presentation time, and the word, sentence or phrase is displayed on Prompter1 250 and Prompter2 252 starting at the optimal timecode indicated in the script, for example where the text “Hello” is displayed on Prompter1 250 from time T287 to T288 and the text “My name is John” is displayed on Prompter2 252 from time T289 to T291. In some embodiments, the script 100 signals that video content analyzers, such as Eye Contact Analyzer 262 and Expression Analyzer 264, and audio analyzers 266, performing such analysis as Natural Language Processing, script adherence, stutter, repeat, and skip detection, are enabled from time T286 to T292, with each video content analyzer and audio analyzer having timecoded weights and target conditions for each timecoded period indicated by script 100, where video and audio may be preprocessed before being passed to analyzers, where each analyzer receives the video stream and reduces to a numerical score the fit of the captured audio or video against one or more desired target qualities, such as a smiles or frowns or furled brows, creating and storing an average numerical score and peak value for each time period from shorter measurements within each time period, and applying a time-varying weight which may be different for each time period to create and store average numerical score and peak value for the raw video clip T286 to T292.

### Time-Aligned Personal Video Commercial Storyboard

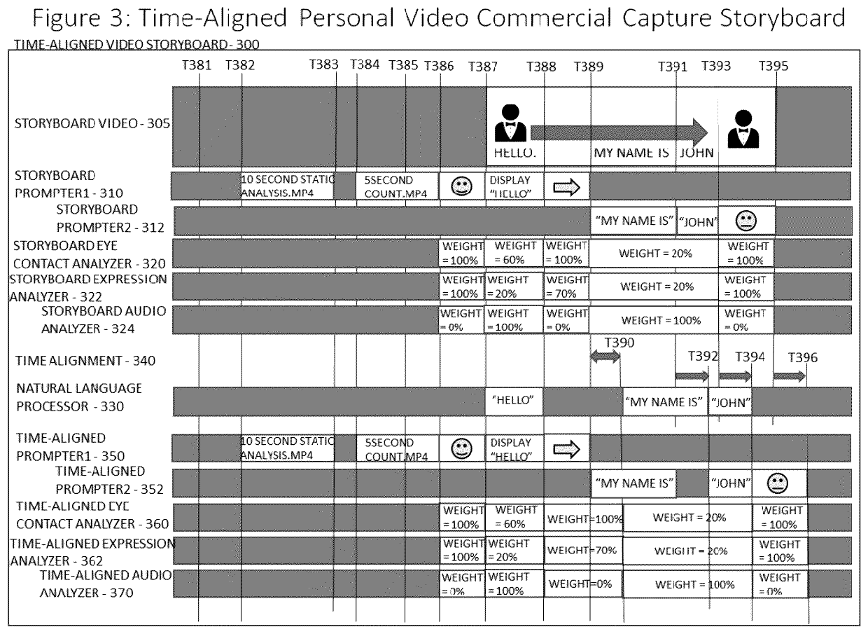

Referring to FIG. 3, in a particular embodiment, a time-aligned personal video commercial capture storyboard 300 that has had its storyboard timecodes modified into time-aligned timecodes by synchronizing all appropriate timecodes in the script for control of prompts, lighting, and video and audio analyzers with the verbal cadence of the client's spoken words as captured by the microphone FIG. 5-528 is provided. The Time-aligned Video Storyboard Overview 300 consists of one or more storyboard rows showing time-based activity for the desired output row Video Storyboard 305. In the instant embodiment, one or more Video Cameras, one or more infra-red video cameras, audio microphones and recorders, lighting, and audio output from this FIG. 3 are omitted for clarity, and showing pre-aligned timing for one or more Storyboard Teleprompter displays 310 and 312, Storyboard eye contact analyzer 320, Storyboard expression analyzer 322, and Storyboard audio analyzer 330, and also showing post-alignment timing for one or more Time-aligned Teleprompter displays 350 and 352, Time-aligned eye contact analyzer 360, Time-aligned expression analyzer 362, and Time-aligned audio analyzer 370. In other embodiments, one or more infra-red video cameras, audio microphones and recorders, lighting, and audio output are also included. In some embodiments, Natural Language Processor 330 performed on some or all of local AI Processor FIG. 5-513, cloud AI processor FIG. 5-583, or Third Party AI Processor FIG. 5-586, detects the time of the start of words in the captured audio stream, such as the start of the word “My” at time T390, and subtracts the expected time of the start of the same word from Time-aligned Prompter1 350 or Time-aligned Prompter2 352, where the word “My” starts at time T389, to determine further the positive or negative Time Alignment 340, which is used to modify all future timecodes, such as T391 to T392, T393 to T394, and T395 to T396, to bring control of all future prompts, and control of lights, cameras, and audio and video analyzers into synchronization with future spoken input. In additional embodiments, expression analyzer 322 uses lip reading or similar visual techniques to detect the time of the start of words in the video stream relative to the expected time of the start of the same word from Time-aligned Prompter1 350 or Time-aligned Prompter2 352 to determine further the positive or negative Time Alignment 340, which is used to modify all future timecodes, such as T391 to T392, T393 to T394, and T395 to T396, to bring control of all future prompts, and control of lights, cameras, and audio and video analyzers into synchronization with future spoken input.

### Personal Video Commercial Studio Process

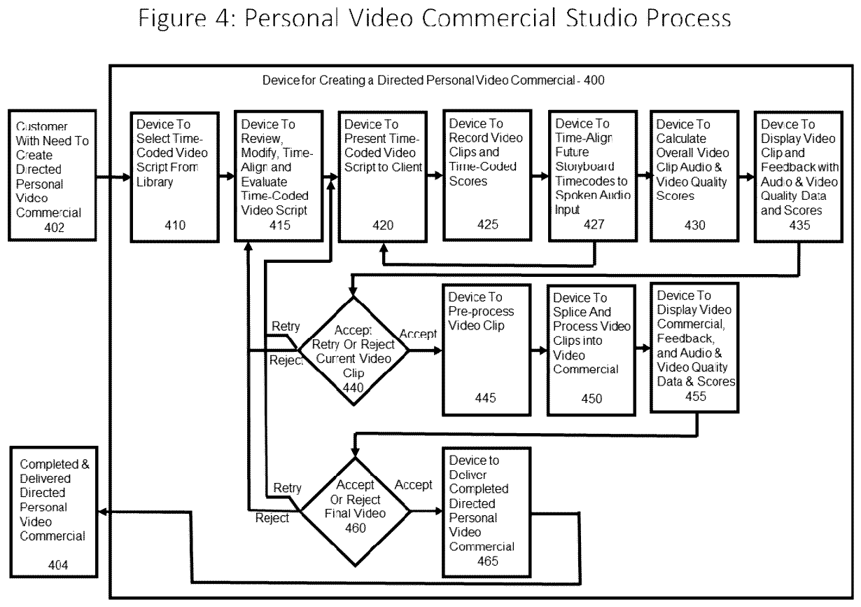

Referring to FIG. 4, in a particular embodiment, a process for a creating and delivering a directed personal video commercial is provided. As shown in FIG. 4, Customer With Need To Create Directed Personal Video Commercial 402 uses Device For Creating a Directed Personal Video Commercial 400 to create Completed & Delivered Directed Personal Video Commercial 404.

The Device 400 includes a Device To Select Time-Coded Video Script From Library 410 to allow the system to recommend and the user to select the best available time-encoded video script template from a pre-existing library of such templates.

The Device 400 then processes and modifies the selected script template using Device To Modify And Evaluate Time-Coded Video Script Text 415 to allow the user to substitute names, services, service areas, phrases or words; adjust script time codes and scoring weights to fit word substitutions; and to help the user self-assess their comfort with the modified script text.

The Device 400 then executes the time-coded script, such as the script 100 described in FIG. 1, using Device To Present Time-Coded Script to Client 420, to present text and non-text prompts, including icons and stage directions to one or more teleprompter displays, and to control one or more video cameras, one or more infra-red video cameras, audio microphones and recorders, and one or more analysis tools such as static defect analyzers, eye contact analyzers, facial expression analyzers, and audio natural language processors and spoken word defect analyzers. While Device 420 controls system functions like lighting, presents the text to the user using teleprompters, and controls audio and video recording equipment and analysis subsystems, the Device To Record Video Clips and Time-Coded Scores 425 records the captured audio and video clips in standard file formats in local, remote or cloud storage, and creates a new version of the script also in local, remote or cloud storage augmented with time-coded weight-adjusted scores from all analysis tools such as static defect analyzers, eye contact analyzers, facial expression analyzers, and audio spoken word defect analyzers.

The Device 400 then modifies the time-codes in the time-coded script, such as the script 100 described in FIG. 1, aligns future prompts and controls without limitation to spoken cadence of the client using Device to Time-Align Future Storyboard Timecodes to Spoken Audio Input 427. uses AI-based speech to text conversion and pattern matching against the script text to determine the offset between the optimal time for each time-coded event and the actual cadence of the user speaking the text. In some embodiments, the offset is applied to adjust the timing of time-coded script controls of teleprompter content, timing of analyzer controls and scoring weights, and timing of audio and video recording. The user can be provided with feedback to increase or speed up cadence if actual recorded timing falls behind the optimal specified timing by decreasing blank intervals, flipping the prompter to new text earlier, or by providing stage directions using secondary displays or indicators or tones. The user can be provided with feedback to decrease or slow down cadence if actual recorded timing is ahead of the optimal specified timing by increasing blank intervals, flipping the prompter to new text later, or by providing stage directions using secondary displays or indicators or tones.

Either contemporaneously with or without the generation of a new version of the script augmented with time-coded weight-adjusted scores using Device 420, or in a post-processing phase following the completion of one video clip or following the completion of all video clips, Device To Calculate Overall Video Clip Audio and Video Quality Scores 430 uses time-coded weight-adjusted scores from all analysis tools to create and display time-based scoring subtotals and an overall scoring figure of merit for each video clip. Based on the scores of individual subsystems, scoring subtotals, overall scoring figure of merit, and other factors such as self-assessed or measured English language fluency, the current video clip is either accepted or rejected in decision box 440. If the current video clip is rejected, the user is provided with another opportunity to change and improve the script to facilitate a better score, and training and suggestions to improve specific problems detected by analysis tools, before starting again with Device 415, or an opportunity to retry the current script starting with Device 420. In some embodiments, the time-based scoring of the audio and video stream may comprise one or more of the following criteria: eye contact; facial emotional analysis; position and rotation; audio legibility; script cadence; video clip, header, and or trailer duration.

When the user accepts a video clip in decision box 440, the video clip is pre-processed in Device To Pre-process Video Clip 445 by using commercially available tools to de-hiss, remove pops and recording defects, adjust audio gain to achieve an optimal sound level, apply video filters and adjustments such as cropping, gamma adjustment and color correction, and to locate and execute optimal trim points for video clip start and end.

After each video clip or all video clips are pre-processed in Device 445, it is spliced into a draft commercial along with optional licensed third-party audio or video clips using Device To Splice and Process Video Clips Into Video Commercial 450 by using commercially available tools starting with a pre-existing or generated title segment and pre-existing or generated ending credit segment, and splicing and optionally applying dissolve filters to splice video and/or audio from each new clip per the storyboard. Some video clips may only supply audio content to provide a consolidated single narration that spans several video clips from which only video was used.

After all video clips are spliced into a draft video using Device 450, the Device To Display Video Commercial, Feedback, and Audio & Video Quality Data & Scores 455 displays the final video with concurrent overlaid or adjacent display of analyzer scores, numeric assessments of overall quality from each analyzer, and an overall figure of merit score and recommendation of accept or reject for the video commercial draft.

The system or user accepts or rejects the draft Video Commercial in Decision box 460. If the draft video is rejected, individual clips may be recommended for rescripting using Device 415 or re-take starting with Device 420. The accepted draft Video Commercial is now a Final Video Commercial.

Device To Complete, Archive, and Deliver Final Video Commercial 465 stores the final video file, the score-augmented script file, associated pre-existing or recorded audio and video files, and recorded client information to remote or cloud storage; deletes all client information from local storage; provides a multi-user account system with login to allow clients controlled access to view and download their Final Video Commercial; and provides accounting and management for licensing, distribution and payment mechanisms for any licensed third party audio or video content.

### Personal Video Commercial Studio System

Referring to FIG. 5, in a particular embodiment, a schematic diagram of a personal video commercial studio with a single personal video station is provided. The Personal Video Commercial Studio 500 comprises of one or more Infra-Red Light Cameras 536; one or more Infra-Red Lamps 534; one or more Visible Light Lamps 532, including stage lights for illumination and indicator lamps to communicate with the user; one or more Speakers 530; one or more microphones 528, none or one or more front glass plates 520, and one or more Primary Camera 526. The Studio 500 components are in close proximity of Customer 590 behind Executive Desk 508 and sitting in Executive Chair 506, so Primary Camera 526 can record video in normal light to record video clip 578, see Static Defects 596 for static defect analysis and to see Customer Facial Expression 594 for facial expression analysis or lip reading, so Infra-Red Camera 526 can record Customer Eye-Tracking 592 using infra-red light for eye-contact analysis, and so Microphone 528 can record user voice for speech to text translation, cadence analysis and spoken word anomaly analysis. Processing may be done locally in the Studio 500 using AI Processor 513 at Local Processor and Memory 512, remotely using AI Processor 583 at Cloud/remote Processing and Storage 582, remotely using Third Party AI Processor 586 at Third Party AI As A Service 584, or in any combination of processors.

Continuing to refer to FIG. 5, Customer at Home 598 using Customer Computer 588 and Customer Internet Connection 588 schedules appointment at Studio 500, evaluates and picks from Script Library 570, accessed over Internet 580, a Selected Score-Augmented Time-Coded Client Script 572, which is modified by the client on the Customer Computer 588 including timecode adjustments to accommodate word substitutions so as to create Modified Score-Augmented Time-Coded Client Script 576. Completed Final Video 578 and Modified Score-Augmented Time-Coded Script 576 are archived in Cloud/remote Processing and Storage 582 for retrieval by customer.

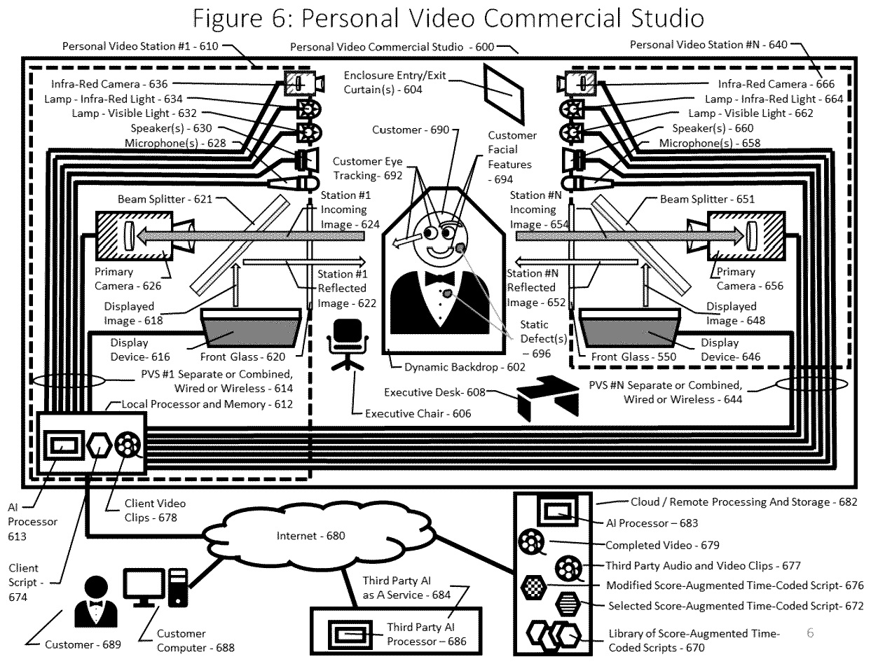

Referring to FIG. 6, in a particular embodiment, a schematic diagram of a personal video commercial studio with multiple personal video stations is provided. The Personal Video Commercial Studio 600 comprises one or more Personal Video Stations 610 and 640, which include Infra-Red-Light Cameras 636 and 666; one or more Infra-Red Lamps 634 and 664; one or more Visible Light Lamps 632 and 662, including stage lights for illumination and indicator lamps to communicate with the user; one or more Speakers 630 and 660; one or more microphones 628 and 658, none or one or more front glass plates 620 and 650, one or more Primary Camera 626 and 656, one or more Beam Splitter 621 and 651. Display Device 616 and 646 project Displayed Image 618 and 648, which reflects on Beam Splitter 621 and 651 to Reflected Image 622 and 652. Interference from exterior light and sound is controlled with Enclosure Entry/Exit Curtains 604.

Continuing to refer to FIG. 6, the Studio 600 components are in close proximity of Customer 690 behind Executive Desk 608 and sitting in Executive Chair 606, so Incoming Image 624 and 654 passes through Beam Splitter 621 and 651 to impinge on Primary Camera 626 and 656 to record video in normal light to record video clip 678, see Static Defects 696 for static defect analysis and to see Customer Facial Expression 494 for facial expression analysis. Infra-red Lamp 634 and 664 illuminate Customer Eye-Tracking 692 to record infra-red image using Infra-red camera 636 and 666 using infra-red light for eye-contact analysis. Microphone 628 records user voice for speech to text translation, cadence analysis and spoken word anomaly analysis. Processing may be done locally in the Studio 600 using Local Processing Engine 612, remotely using Cloud/remote Processing and Storage 682, or in a combination of both.

Continuing to refer to FIG. 6, Customer at Home 698 using Customer Computer 688 and Customer Internet Connection 688 schedules appointment at Studio 600, evaluates and picks from Script Library 670, accessed over Internet 680, a Selected Score-Augmented Time-Coded Client Script 572, which is modified by the client on the Customer Computer 688 including timecode adjustments to accommodate word substitutions so as to create Modified Score-Augmented Time-Coded Client Script 676. Completed Final Video 678 and Modified Score-Augmented Time-Coded Script 676 are archived in Cloud/remote Processing and Storage 682 for retrieval by customer.

### Smartphone Personal Video Commercial Studio

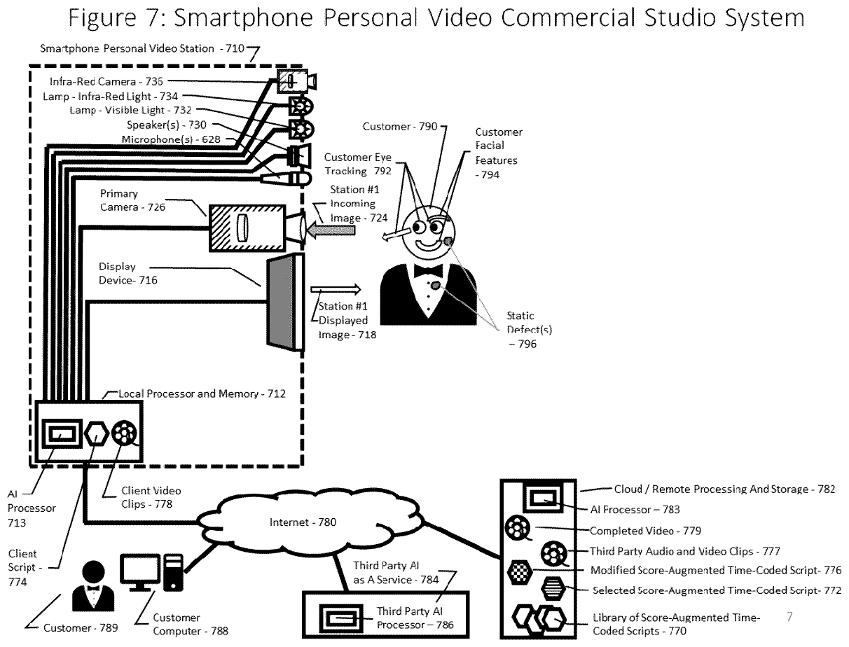

Referring to FIG. 7, in a particular embodiment, a schematic diagram of a personal video commercial studio using a smartphone is provided. The Smartphone Personal Video Commercial Studio on 700 comprises of one or more Infra-Red Light Cameras 736; one or more Infra-Red Lamps 734; one or more Visible Light Lamps 532, including indicator lamps or displays on the smartphone display 716 to communicate with the user; one or more Speakers 730; one or more microphones 728, one or more displays 716, and one or more Primary Camera 726. The Smartphone Studio 700 components are in close proximity of Customer 790, so Primary Camera 726 can record video in normal light to record video clip 778, see Static Defects 796 for static defect analysis and to see Customer Facial Expression 794 for facial expression analysis or lip reading, so Infra-Red Camera 726 can record Customer Eye-Tracking 792 using infra-red light for eye-contact analysis, and so Microphone 728 can record user voice for speech to text translation, cadence analysis and spoken word anomaly analysis. Processing may be done locally in the Studio 700 using AI Processor 713, for example Apple All Bionic processor or Qualcomm SnapDragon 845 processor each with dedicated AI processing hardware, at Local Processor and Memory 712, remotely using AI Processor 783 at Cloud/remote Processing and Storage 782, remotely using Third Party AI Processor 786 at Third Party AI As A Service 784, or in any combination of processors.

Continuing to refer to FIG. 7, Customer at Home 798 using Customer Computer 788 or using Smartphone studio 700, each along with Customer Internet Connection 788, evaluates and picks from Script Library 770, accessed over Internet 780, a Selected Score-Augmented Time-Coded Client Script 772, which is modified by the client on the Customer Computer 788 or Smartphone Studio 700 including timecode adjustments to accommodate word substitutions so as to create Modified Score-Augmented Time-Coded Client Script 776. Completed Final Video 778 and Modified Score-Augmented Time-Coded Script 776 are stored in Smartphone Studio 700 and archived in Cloud/remote Processing and Storage 782 for retrieval by customer.

Digital processing device

In some embodiments, the systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle Solaris®, Windows Server®, and Novell NetWare®. Those of skill in the art will recognize that suitable personal computer operating systems include, by way of non-limiting examples, Microsoft Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion° BlackBerry OS®, Google Android®, Microsoft® Windows Phone® OS, Microsoft® Windows Mobile® OS, Linux®, and Palm® WebOSX. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

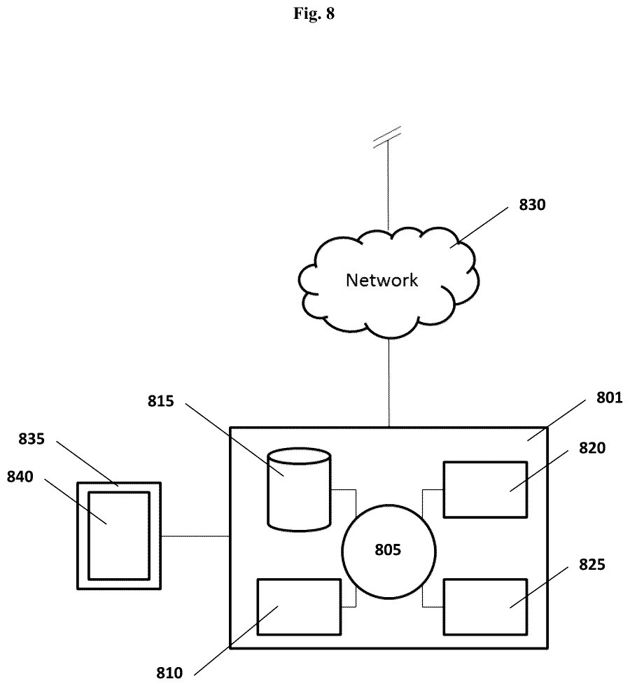

Referring to FIG. 8, in a particular embodiment, an exemplary digital processing device 801 is programmed or otherwise configured to present tutor and learner interfaces for scheduling and conducting a tutoring session. In this embodiment, the digital processing device 801 includes a central processing unit (CPU, also “processor” and “computer processor” herein), which can be a single core or multi core processor, or a plurality of processors for parallel processing. The digital processing device 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 805 through a communication bus (solid lines), such as a motherboard. The storage unit 815 can be a data storage unit (or data repository) for storing data. The digital processing device 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the device 801, can implement a peer-to-peer network, which may enable devices coupled to the device 801 to behave as a client or a server.

Continuing to refer to FIG. 8, the CPU 805 can execute a sequence of machine-readable instructions, which can be embodied in a program or software. The instructions may be stored in a memory location, such as the memory 810. The instructions can be directed to the CPU 805, which can subsequently program or otherwise configure the CPU 805 to implement methods of the present disclosure. Examples of operations performed by the CPU 805 can include fetch, decode, execute, and write back. The CPU 805 can be part of a circuit, such as an integrated circuit. One or more other components of the device 801 can be included in the circuit. In some cases, the circuit is an application specific integrated circuit (ASIC) or a field programmable gate array (FPGA).

Continuing to refer to FIG. 8, the storage unit 815 can store files, such as drivers, libraries and saved programs. The storage unit 815 can store user data, e.g., user preferences and user programs. The digital processing device 801 in some cases can include one or more additional data storage units that are external, such as located on a remote server that is in communication through an intranet or the Internet.

Continuing to refer to FIG. 8, the digital processing device 801 can communicate with one or more remote computer systems through the network 830. For instance, the device 801 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iphone, Android-enabled device, Blackberry®), or personal digital assistants.

Methods as described herein can be implemented by way of machine (e.g., computer processor) executable code stored on an electronic storage location of the digital processing device 801, such as, for example, on the memory 810 or electronic storage unit 815. The machine executable or machine readable code can be provided in the form of software. During use, the code can be executed by the processor. In some cases, the code can be retrieved from the storage unit 815 and stored on the memory 810 for ready access by the processor 805. In some situations, the electronic storage unit 815 can be precluded, and machine-executable instructions are stored on memory 810.

### Non-Transitory Computer Readable Storage Medium

In some embodiments, the systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

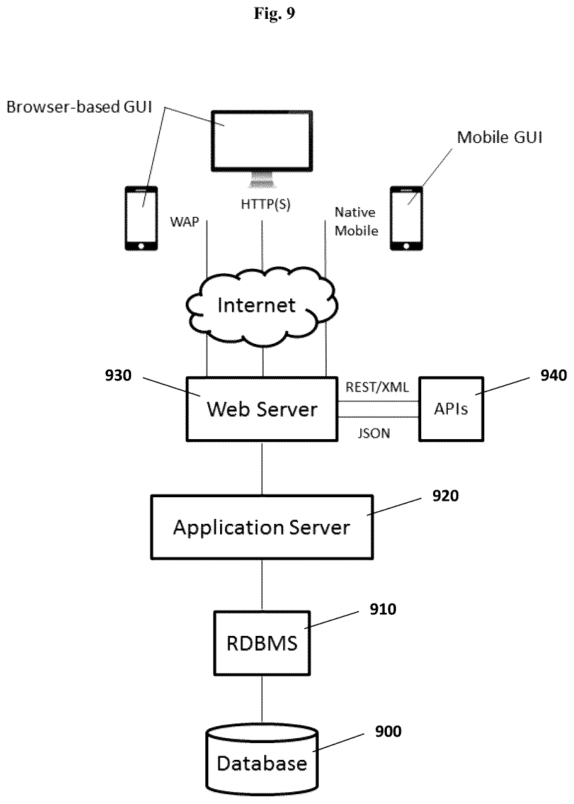

Referring to FIG. 9, in a particular embodiment, an application provision system comprises one or more databases 900 accessed by a relational database management system (RDBMS) 910. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 920 (such as Java servers, .NET servers, PHP servers, and the like) and one or more web servers 930 (such as Apache, IIS, GWS and the like). The web server(s) optionally expose one or more web services via app application programming interfaces (APIs) 940. Via a network, such as the Internet, the system provides browser-based and/or mobile native user interfaces.

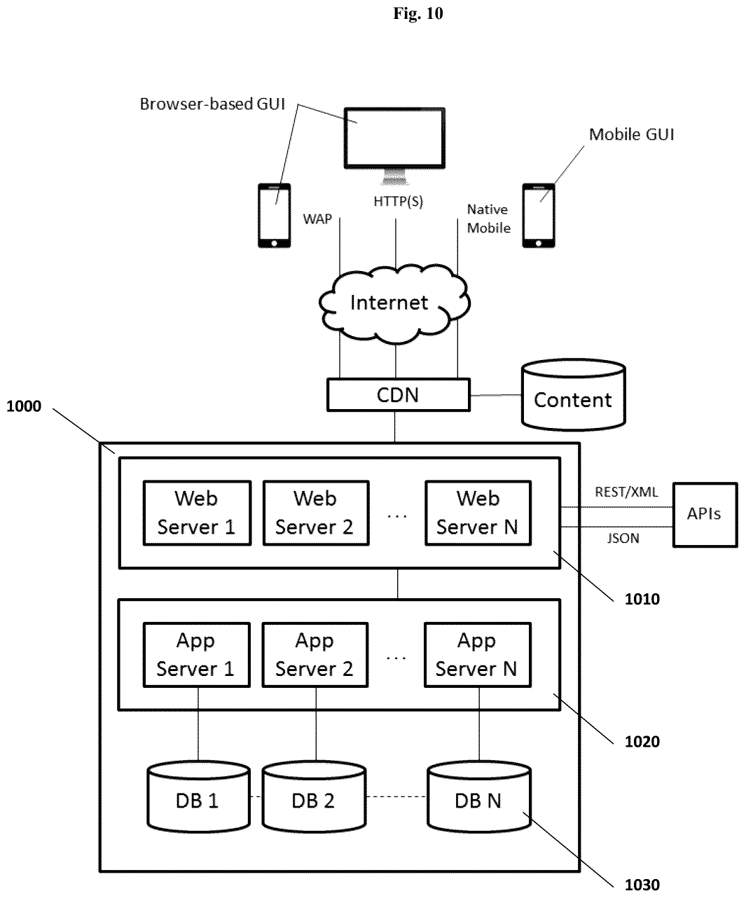

Referring to FIG. 10, in a particular embodiment, an application provision system alternatively has a distributed, cloud-based architecture 1000 and comprises elastically load balanced, auto-scaling web server resources 1010 and application server resources 1020 as well synchronously replicated databases 1030.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry®SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and methods disclosed herein include one or more databases, or use of the same. In view of the disclosure provided herein, those of skill in the art will recognize that many databases are suitable for storage and retrieval of child and caregiver information. In various embodiments, suitable databases include, by way of non-limiting examples, relational databases, non-relational databases, object oriented databases, object databases, entity-relationship model databases, associative databases, and XML databases. In some embodiments, a database is Internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising:
a) at least one personal video station comprising a visible light, a speaker, a microphone, a recording camera, a beam splitter, and a display device; and
b) a digital processing device comprising at least one processor, a memory, an operating system configured to perform executable instructions, and instructions executable by the at least one processor to provide an application for creating a personal video commercial for a user, the personal video commercial comprising a calculated overall quality score, the application comprising:
i) a script selection module selecting a script template from a library of one or more pre-existing script templates for a personal video commercial, wherein the script selection module selects the script template based input from the user, wherein the selected script template comprises text and metadata, wherein the metadata comprises one or more sets of timecodes, weights, and scoring targets for one or more text and commands for the at least one personal video station, wherein each timecode is associated with a start or end of a phoneme, word, phrase, or sentence and applied to a start or stop of one or more elements of the at least one personal video station or one or more artificial intelligence (AI)-based audio and video characterization and measurement tools, wherein the weights and the scoring targets are associated with the timecodes, are time-varying across the script template, are for static defect analysis, spoken anomaly detection, cadence analysis, head position analysis, eye contact measurement, and emotional content analysis, and are applied to the one or more AI-based audio and video characterization and measurement tool scores, wherein the script selection module modifies the text and metadata based on user answers to questions included as part of the template to create a modified script, wherein the modified text comprises word substitutions or word additions to the text;
ii) a script review module (A) accepting, from the microphone, audio data of the user reading some of the modified text; (B) accepting, from the recording camera, video data of the user reading some of the modified text; (C) determining an audio score and a video score of the modified script reading using the time-varying weights and scoring targets; (D) modifying the modified text and the modified metadata until the script review module accepts audio data and video data that passes a threshold audio score and a threshold video score; and (E) creating a threshold passing script, wherein the threshold passing script comprises scripted text and scripted metadata, wherein the scripted metadata comprises one or more sets of scripted timecodes, scripted weights, and scripted scoring targets for one or more scripted text and commands for the at least one personal video station;
iii) a display device project some of the scripted text to the beam splitter at a particular scripted timecode, wherein the projection is reflected to the user in conjunction with visible light and the recording device recording the user;
iv) an alignment module, in real-time during recording of the personal video commercial, (A) accepting, from the microphone, audio data of the user reading the projected script text as the user is being recorded; (B) determining a read timecode for the read projected text; (C) calculating an offset between the read timecode and the particular scripted timecode of the projected script text, wherein calculating the offset comprises comparing a start of a phoneme, word, phrase, or sentence in the read timecode of the projected text reading with a start of the utterance of a phoneme, word, phrase, or sentence in the particular scripted timecode of the projected script text; and (D) aligning, based on the calculated offset, one or more scripted timecodes of scripted text not yet projected and a command not yet executed to create aligned scripted text and command;
v) the display device projecting the aligned scripted text and the at least one personal video station executing the aligned command at the one or more aligned scripted timecodes;
vi) a scoring module generating the overall quality score for the recording, wherein the scoring comprises (A) comparing the recording with the one or more scripted weights and scripted scoring targets and (B) weighted output scores of the AI-based audio and video characterization and measurement tools for static defect analysis, spoken anomaly detection, cadence analysis, head position analysis, eye contact measurement, and emotional content analysis; and
vii) a feedback module displaying the score and providing audio feedback to the user through the speaker.

2. The system of claim 1 further comprising an editing module editing, mixing, cutting, or splicing together audio and video clips.

3. The system of claim 1, wherein the at least one personal video station further comprises an infra-red camera and an infra-red light.

4. The system of claim 3, wherein the infra-red camera and infra-red light tracks eye movement.

5. The system of claim 1, wherein the at least one personal video station comprises, 2, 3, 4, 5, 6, 7, 8, 9, or 10 personal video stations.

6. The system of claim 1, wherein the at least one personal video station comprises a laptop or desktop computer with internet access, an embedded or external camera, and microphone.

7. The system of claim 1, wherein the at least one personal video station comprises a smart TV with internet access, an embedded or external camera, and microphone.

8. The system of claim 1, wherein the at least one personal video station comprises a mobile device with internet access and a processor comprising artificial intelligence processing capabilities.

9. The system of claim 1, wherein the personal video commercial presents multiple users over the duration of the video.

10. The system of claim 9, wherein the multiple users are presented in sequence or concurrently.

11. The system of claim 1, wherein the personal video commercial presents a product for sale or review by one or more individuals in a video.

12. The system of claim 1, wherein the personal video commercial lasts in duration from 10 seconds to 5 minutes.

13. The system of claim 1, wherein the timecodes comprise one or more of ideal cadence, slowest permissible cadence and the fastest permissible cadence, stutter detection, ambient noise assessment, ideal eye contact, ideal head position, sweat and stain detection, and facial emotional analysis, time-encoded controls for lighting and audio and visual indicators, time-encoded stage direction for secondary displays in text, audio or video formats, and time-encoded training directions for prompts in normal and training modes.

14. The system of claim 1, wherein the spoken anomaly detection comprises detection of language fluency, stuttering, missing, or repeating.

15. The system of claim 1, wherein the static defect analysis comprises sweat, spot, or stain detection, hair or makeup assessment, position or rotation assessment, lighting and background assessment, and ambient noise assessment and analysis.

16. The system of claim 1, wherein the pre-existing script templates comprise samples of representative dialogue with one or more of ideal cadence, optimal time-varying weights, and scoring targets of a specific person's characteristics to be impersonated or duplicated, wherein the specific person's characteristics comprises the specific person's mannerism or voice.

17. A method of creating a personal video commercial for a user, the personal video commercial comprising a calculated overall quality score, the method comprising:
a) providing at least one personal video station comprising a visible light, a speaker, a microphone, a recording camera, a beam splitter, and a display device;
b) selecting a script template from a library of one or more pre-existing script templates for a personal video commercial based on input from the user, wherein the selected script template comprises text and metadata, wherein the metadata comprises one or more sets of timecodes, weights, and scoring targets for one or more text and commands for the at least one personal video station, wherein each timecode is associated with a start or end of a phoneme, word, phrase, or sentence and applied to a start or stop of one or more elements of the at least one personal video station or one or more artificial intelligence (AI)-based audio and video characterization and measurement tools, wherein the weights and the scoring targets are associated with the timecodes, are time-varying across the script template, are for static defect analysis, spoken anomaly detection, cadence analysis, head position analysis, eye contact measurement, and emotional content analysis, and are applied to the one or more AI-based audio and video characterization and measurement tool scores, and modifying the text and metadata based on user answers to questions included as part of the template to create a modified script, wherein the modified text comprises word substitutions or word additions to the text;
c) (A) accepting, from the microphone, audio data of the user reading some of the modified text; (B) accepting, from the recording camera, video data of the user reading some of the modified text; (C) determining an audio score and a video score of the modified script reading using the time-varying weights and scoring targets; (D) modifying the modified text and the modified metadata until the audio data and video data passes a threshold audio score and a threshold video score; and (E) creating a threshold passing script template, wherein the threshold passing script comprises scripted text and scripted metadata, wherein the scripted metadata comprises one or more sets of scripted timecodes, scripted weights, and scripted scoring targets for one or more scripted text and commands for the at least one personal video station;
d projecting some of the scripted text to the beam splitter at a particular scripted timecode, wherein the projection is reflected to the user in conjunction with visible light and the recording device recording the user;
e) in real-time during recording of the personal video commercial, (A) accepting, from the microphone, audio data of the user reading the projected script text as the user is being recorded; (B) determining a read timecode for the read projected text; (C) calculating an offset between the read timecode and the particular scripted timecode of the projected script text, wherein calculating the offset comprises comparing a start of the utterance of a phoneme, word, phrase, or sentence in the read timecode of the projected text reading with a start of a phoneme, word, phrase, or sentence in the particular scripted timecode of the projected script text; and (D) aligning, based on the calculated offset, one or more scripted timecodes of scripted text not yet projected and a command not yet executed to create aligned scripted text and command;
f) projecting the aligned scripted text and executing the aligned command at the one or more aligned scripted timecodes;
g) generating the overall quality score for the recording, wherein the scoring comprises (A) comparing the recording with the one or more scripted weights and scripted scoring targets and (B) weighted output scores of the AI-based audio and video characterization and measurement tools for static defect analysis, spoken anomaly detection, cadence analysis, head position analysis, eye contact measurement, and emotional content analysis; and
h) displaying the score and providing audio feedback to the user through the speaker.

18. The method of claim 17 further comprising one or more of editing, mixing, cutting, and splicing audio and video clips.

19. The method of claim 17, wherein the at least one personal video station further comprises an infra-red camera and an infra-red light.

20. The method of claim 19, further tracking the eye movement of the user using the infra-red camera or infra-red light.

21. The method of claim 17, wherein the weights and scoring targets are for one or more of ideal cadence, slowest permissible cadence and the fastest permissible cadence, stutter detection, ambient noise assessment, ideal eye contact, ideal head position, sweat and stain detection, and facial emotional analysis, time-encoded controls for lighting and audio and visual indicators, time-encoded stage direction for secondary displays in text, audio or video formats, and time-encoded training directions for prompts in normal and training modes.

22. The method of claim 17, wherein the spoken anomaly detection comprises detection of language fluency, stuttering, missing, or repeating.

23. The method of claim 17, wherein the pre-existing script templates comprise samples of representative dialogue with one or more of ideal cadence, optimal time-varying weights, and scoring targets of a specific person's characteristics to be impersonated or duplicated, wherein the specific person's characteristics comprises the specific person's mannerism or voice.

24. The method of claim 17, wherein the static defect analysis comprises sweat, spot, or stain detection, hair or makeup assessment, position or rotation assessment, lighting and background assessment, and ambient noise assessment and analysis.

25. The system of claim 1, wherein the one or more scripted text and commands for the at least one personal video station comprises prompts for the user to smile.

26. The system of claim 1, wherein the aligning comprises moving the one or more scripted timecodes of scripted text not yet projected earlier or later and a command not yet executed earlier or later in the thresholding passing script to synchronize to a cadence of the projected reading.

27. The method of claim 17, wherein the one or more scripted text and commands for the at least one personal video station comprises prompts for the user to smile.

28. The method of claim 17, wherein the aligning comprises moving the one or more scripted timecodes of scripted text not yet projected earlier or later and a command not yet executed earlier or later in the thresholding passing script to synchronize to a cadence of the projected reading.
